(19) United States
(12) Patent Application Publication
(10) Pub. No.: US 2021/0285508 A1
(43) Pub. Date: Sep. 16, 2021

(54) DISK BRAKE AND PISTON BOOT

(71) Applicant: Hitachi Automotive Systems, Ltd., Ibaraki (JP)

(72) Inventors: Takahito OSADA, Nishiyatsushiro-gun, Yamanashi (JP); Shigeru HAYASHI, MinamiALPS-shi, Yamanashi (JP); Satoshi NAKAMURA, MinamiALPS-shi, Yamanashi (JP)

(21) Appl. No.: 17/255,562

(22) PCT Filed: Jun. 14, 2019
(86) PCT No.: PCT/JP2019/023613

§ 371 Date: Dec. 23, 2020

(30) Foreign Application Priority Data
Jun. 27, 2018 (JP) 2018-121838

(51) Int. Cl. F16D 65/18; F16D 55/226

(52) U.S. Cl. CPC F16D 65/18; F16D 2125/08; F16D 55/226

(57) ABSTRACT

A disk brake includes a cylinder including a bottomed bore portion in which a piston is received movably in an axial direction. The cylinder includes an annular small-diameter stepped portion formed on an opening edge side of the bore portion. The disk brake includes the piston configured to press a friction pad against a disk, and a piston boot disposed between a distal end side of the piston and the small-diameter stepped portion. The piston boot includes a large-diameter fitted portion configured to be fitted to the small-diameter stepped portion. An annular protrusion portion is provided on an inner peripheral side of the large-diameter fitted portion. The annular protrusion portion is shaped such that rigidity thereof against a force directed from the opening edge side toward a bottom portion side of the bore portion is lower than rigidity thereof against a force directed from the bottom portion side.

### TECHNICAL FIELD

The present invention relates to a disk brake configured to apply a braking force to a vehicle such as an automobile and a piston boot used for the disk brake.

### BACKGROUND ART

Generally, a disk brake mounted on a vehicle such as an automobile applies a braking force to the vehicle by causing a piston fittedly inserted in a bore portion of a cylinder to press a friction pad. An annular stepped portion is formed on the opening edge side of the cylinder, and a flexible piston boot is provided between this stepped portion and the piston. The piston boot includes an annular fitted portion fitted to the stepped portion of the cylinder, and an annular protrusion portion is provided on the inner peripheral surface of this fitted portion. This annular protrusion portion secures sealability between the piston boot and the outer peripheral surface of the piston.

### CITATION LIST

### Patent Literature

PTL 1: Japanese Patent Application Public Disclosure No. 2013-11301

### SUMMARY OF INVENTION

### Technical Problem

However, in a case where an annular metallic member is contained in the fitted portion of the piston boot, the rigidity of the annular protrusion portion increases. This raises such a problem that lubricant oil applied to the outer peripheral surface of the piston is scraped off by the annular protrusion portion when the piston is inserted into the bore portion of the cylinder at the time of assembling the disk brake, and this leads to a reduction in the slidability of the piston on the piston boot.

### Solution to Problem

The present invention has been made in consideration of the above-described problem with PTL 1, and an object of the present invention is to provide a disk brake capable of excellently securing the slidability of a piston on a piston boot and a piston boot used for the disk brake.

To achieve the above-described object, a disk brake according to one aspect of the present invention includes a cylinder including a bottomed bore portion in which a piston is received movably in an axial direction. The cylinder includes an annular stepped portion formed on an opening edge side of the bore portion on which a distal end of the piston protrudes. The annular stepped portion has a larger diameter dimension than an inner diameter of the bore portion. The disk brake includes the piston configured to press at least one of a pair of pads facing both surfaces of a disk, respectively, and a piston boot disposed between a distal end side of the piston and the stepped portion of the cylinder. The piston boot includes a bellows portion extensible and compressible according to a movement of the piston. The piston boot includes an annular fitted portion formed integrally with the bellows portion. The fitted portion contains an annular metallic member, and is configured to be fitted to the stepped portion. The piston boot further includes an annular protrusion portion provided on an inner peripheral side of the fitted portion. The annular protrusion portion is configured to abut against an outer peripheral surface of the piston. Rigidity of the annular protrusion portion against a force directed from the opening edge side of the bore portion toward a bottom portion of the bore portion in the axial direction of the piston is lower than rigidity thereof against a force directed from the bottom portion of the bore portion toward the opening edge side of the bore portion in the axial direction of the piston.

Further, a piston boot according to one aspect of the present invention is disposed between a stepped portion formed on an opening edge side of a cylinder and a distal end side of a piston. The cylinder is provided in a caliper of a disk brake, and includes a bottomed bore portion. The piston is received in the bore portion movably in an axial direction. The piston boot includes a bellows portion extensible and compressible according to a movement of the piston, and an annular fitted portion formed integrally with the bellows portion. The fitted portion contains an annular metallic member, and is configured to be fitted to the stepped portion. The piston boot further includes an annular protrusion portion provided on an inner peripheral side of the fitted portion. The annular protrusion portion is configured to abut against an outer peripheral surface of the piston. Rigidity of the annular protrusion portion against a force directed from the opening edge side of the bore portion toward a bottom portion of the bore portion in the axial direction of the piston is lower than rigidity thereof against a force directed from the bottom portion of the bore portion toward the opening edge side of the bore portion in the axial direction of the piston.

### Advantageous Effects of Invention

According to the one aspects of the present invention, it is possible to excellently secure the slidability of the piston on the piston boot.

### BRIEF DESCRIPTION OF DRAWINGS

FIG. 1 is a plan view of the disk brake according to a first embodiment of the present invention.

FIG. 2 is a cross-sectional view of the disk brake as viewed from a direction indicated by arrows II and II in FIG. 1.

FIG. 3 is a cross-sectional view illustrating a piston boot in FIG. 2 alone.

FIG. 4 is an enlarged cross-sectional view illustrating a large-diameter fitted portion, a bellows portion, a small-diameter fitted portion, and a metallic member in FIG. 3 in an enlarged manner.

FIG. 5 is a cross-sectional view illustrating how a piston is inserted into a bore portion of the cylinder.

FIG. 6 is a cross-sectional view of a similar position to FIG. 5 that illustrates how an annular protrusion portion is deformed when the piston is inserted into the bore portion of the cylinder.

FIG. 7 is an enlarged cross-sectional view of a VII portion indicating the piston boot in FIG. 6.

FIG. 8 is an enlarged cross-sectional view of a similar position to FIG. 4 that illustrates a piston boot according to a second embodiment of the present invention.

FIG. 9 is an enlarged cross-sectional view of a similar position to FIG. 4 that illustrates a piston boot according to a third embodiment of the present invention.

### DESCRIPTION OF EMBODIMENTS

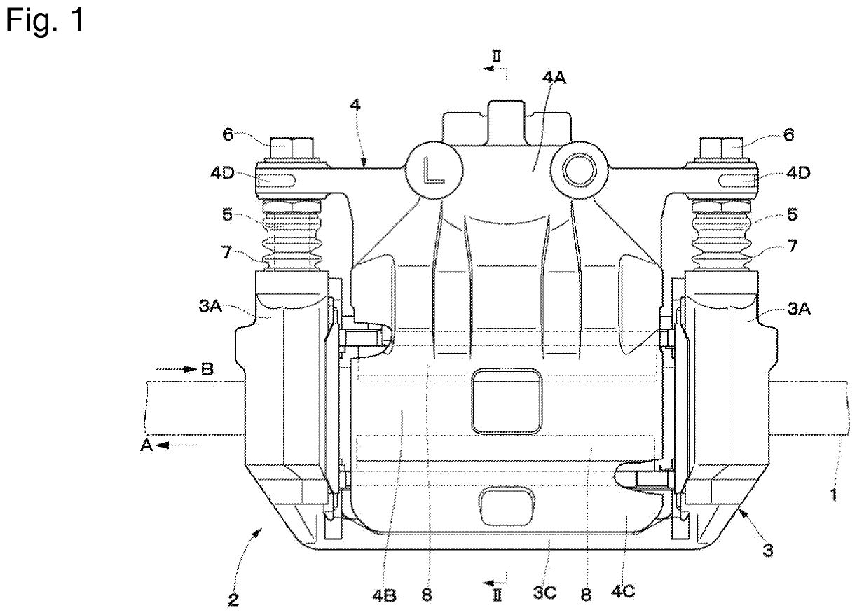

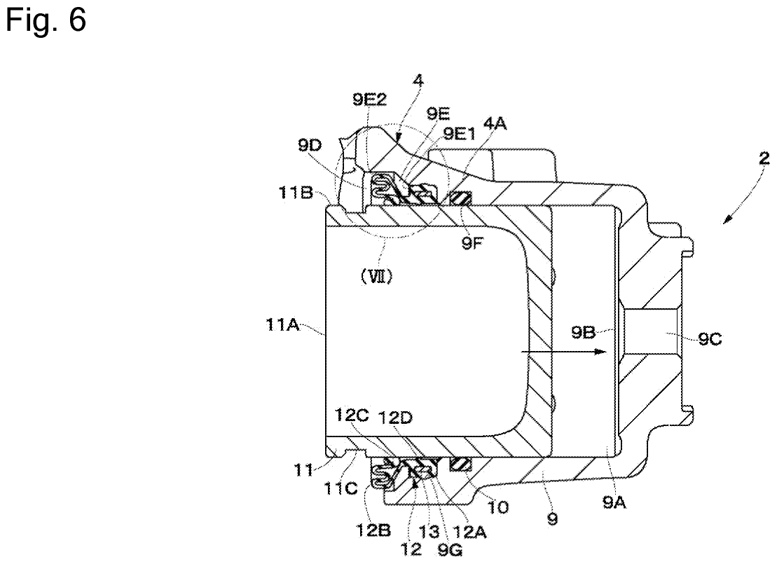

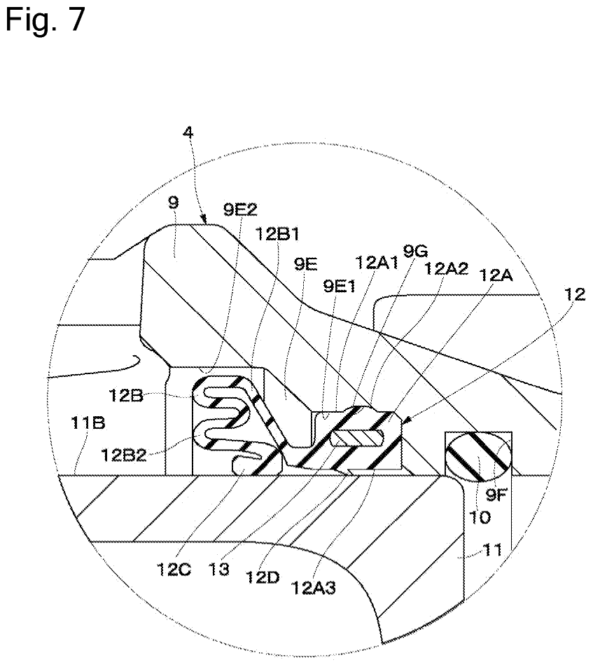

In the following description, embodiments for implementing the present invention will be described in detail with reference to the attached drawings. First, a disk brake and a piston boot according to a first embodiment of the present invention will be described with reference to FIGS. 1 to 7.

A disk 1 illustrated in FIG. 1 is configured to, for example, rotate in a direction indicated by an arrow A in FIG. 1 together with a wheel (not illustrated) when a vehicle runs in an advancing direction, and rotate in a direction indicated by an arrow B when the vehicle runs backward.

A disk brake 2 according to the first embodiment includes a carrier 3 as a mount member fixed to a non-rotatable portion (not illustrated) of the vehicle body side. This carrier 3 includes a pair of arm portions 3A and 3A, and a thick support portion 3B. The pair of arm portions 3A and 3A is disposed so as to axially extend across over the outer peripheral side of the disk 1 while being spaced apart in a rotational direction (a circumferential direction) of the disk 1. The pair of arm portions 3A and 3A extend in an axial direction of the disk 1. The support portion 3B is provided so as to integrally connect the respective proximal end sides of the arm portions 3A to each other, and is fixed to the non-rotatable portion of the vehicle on an inner side, which is one side in the axial direction of the disk 1.

Further, a reinforcement beam 3C is integrally formed on the carrier 3. The reinforcement beam 3C connects the respective distal end sides of the arm portions 3A to each other on an outer side, which is the other side in the axial direction of the disk 1. Due to this configuration, these arm portions 3A of the carrier 3 are integrally connected to each other via the support portion 3B on the inner side of the disk 1, and are also integrally connected to each other via the reinforcement beam 3C on the outer side of the disk 1. Pad guides (not illustrated) are formed on the arm portions 3A on the both sides of the disk 1 in the axial direction, respectively. The pad guides guide friction pads 8 and 8, which will be described below, in the axial direction of the disk 1, and are each shaped like an open sided rectangle-shaped sectional configuration.

A caliper 4 is slidably supported on the carrier 3. The caliper 4 includes an inner leg portion 4A, a bridge portion 4B, and an outer leg portion 4C. The inner leg portion 4A is provided on the inner side of the disk 1. The bridge portion 4B is provided in a manner extending from the inner leg portion 4A to the outer side of the disk 1 so as to extend across over the outer peripheral side of the disk 1 between the two arm portions 3A of the carrier 3. The outer leg portion 4C extends from the outer side, which corresponds to the distal end side of the bridge portion 4B, inward in a radial direction of the disk 1, and forms a two-pronged claw portion 4C1 on the distal end side thereof. Then, a cylinder 9 and a piston 11, which will be described below, are provided in the inner leg portion 4A of the caliper 4.

Further, a pair of mount portions 4D and 4D protruding in the rotational direction of the disk 1 is provided on the inner leg portion 4A. The mount portions 4D support the entire caliper 4 slidably relative to the respective arm portions 3A of the carrier 3 via sliding pins 5 and 5, respectively. These sliding pins 5 are fastened to the respective mount portions 4D of the caliper 4 with use of bolts 6 and 6, respectively. The respective distal end sides of the sliding pins 5 are slidably and fittedly inserted in pin holes (not illustrated) formed on the respective arm portions 3A of the carrier 3 along the axial direction of the disk 1. Protection boots 7 and 7 are attached between the two arm portions 3A and the two sliding pins 5, respectively, and prevent rainwater or the like from entering between the respective sliding pins 5 and the pin holes of the respective arm portions 3A.

The friction pads 8 and 8 are disposed while making a pair in a state facing the both surfaces (the inner side and the outer side) of the disk 1. These friction pads 8 and 8 on the inner side and the outer side each include a lining 8A, which receives a frictional force by contacting the disk 1. When the disk brake 2 is actuated, a brake hydraulic pressure is supplied into a bore portion 9A of the cylinder 9, which will be described below, and the piston 11 moves toward the disk 1. Due to this movement, the friction pad 8 on the inner side is pressed against the disk 1 by the piston 11, and the caliper 4 is displaced toward the inner side due to a reaction force from the piston 11. As a result, the claw portion 4C1 of the outer leg portion 4C presses the friction pad 8 on the outer side toward the disk 1, and the friction pads 8 and 8 on the inner side and the outer side are pressed against the both surfaces of the disk 1, by which a braking force is applied to the disk 1.

The cylinder 9 is provided in the inner leg portion 4A of the caliper 4. The cylinder 9 includes the bore portion 9A formed by a bottomed circular hole, and the piston 11 is slidably and fittedly inserted in the bore portion 9A. A bottom portion 9B of the bore portion 9A is formed on one axial side of the cylinder 9, and a brake fluid passage 9C is formed at the central portion of the bottom portion 9B so as to extend therethrough axially. The brake hydraulic pressure is supplied into and discharged from the bore portion 9A of the cylinder 9 via this brake fluid passage 9C. An opening edge 9D is formed on the other axial side of the cylinder 9, and the piston 11 is inserted into the bore portion 9A via this opening edge 9D.

An annular stepped portion 9E is formed on the opening edge 9D side of the cylinder 9 coaxially with the bore portion 9A. The annular stepped portion 9E has a larger diameter dimension than the inner diameter of the bore portion 9A. The stepped portion 9E includes a small-diameter stepped portion 9E1 and a large-diameter stepped portion 9E2. The small-diameter stepped portion 9E1 is located on the bottom portion 9B side. The large-diameter stepped portion 9E2 has a larger diameter dimension than the diameter dimension of the small-diameter stepped portion 9E1 and is located axially adjacent to the small-diameter stepped portion 9E1. A large-diameter fitted portion 12A of a piston boot 12, which will be described below, is fitted to the small-diameter stepped portion 9E1, and a bellows portion 12B of the piston boot 12, which will be described below, is placed in the large-diameter stepped portion 9E2. An annular seal groove 9F is formed at a position on the bottom portion 9B side with respect to the stepped portion 9E of the cylinder 9 along the entire circumference thereof. An O-ring 10 is set in the seal groove 9F, and this O-ring 10 seals between the inner peripheral surface of the bore portion 9A of the cylinder 9 and an outer peripheral surface 11B of the piston 11, which will be described below.

The piston 11 is axially movably received in the bore portion 9A of the cylinder 9. The piston 11 is formed into a bottomed cylindrical shape, and a distal end 11A of the piston 11 protrudes from the bore portion 9A into abutment with the friction pad 8. The piston 11 protrudes from the bore portion 9A to press the friction pad 8 toward the disk 1 due to the supply of the brake hydraulic pressure into the bore portion 9A via the brake fluid passage 9C of the cylinder 9. An annular groove 11C is formed on the outer peripheral surface 11B of the piston 11 on the distal end 11A side along the entire circumference thereof. A small-diameter fitted portion 12C of the piston boot 12, which will be described below, is fitted to this annular groove 11C.

Next, the piston boot used in the first embodiment will be described.

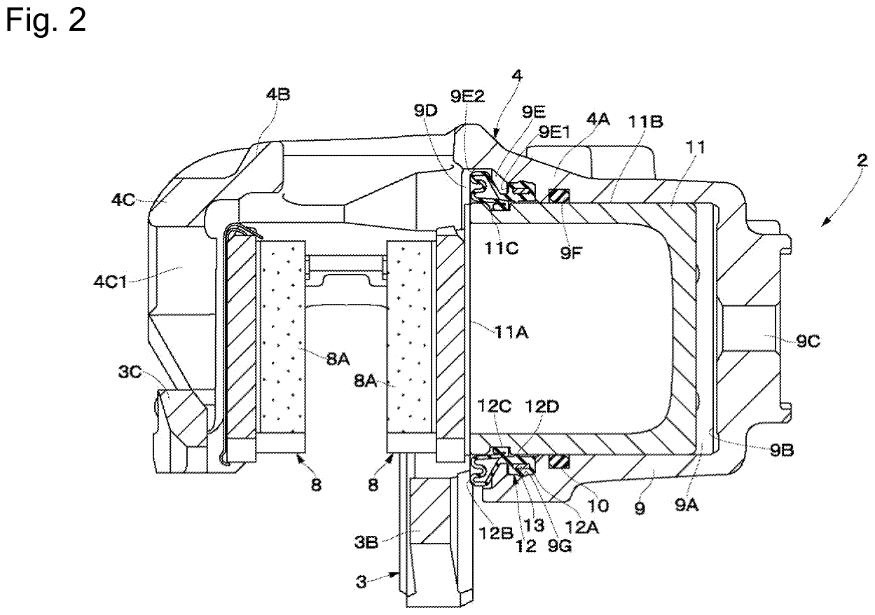

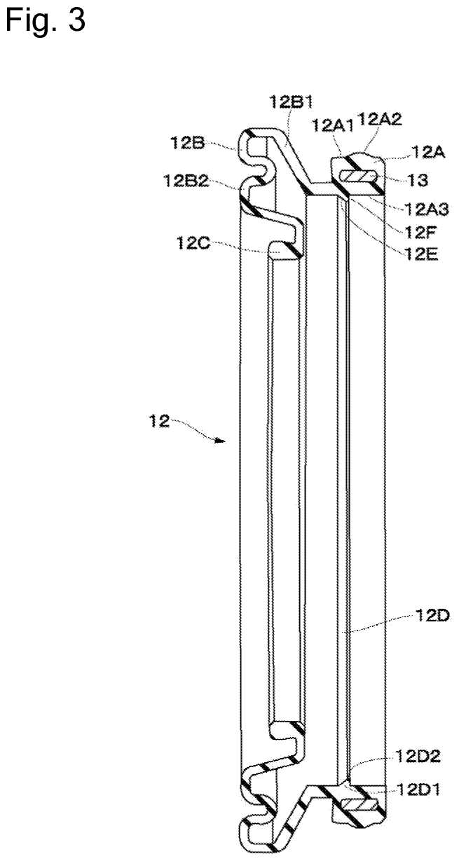

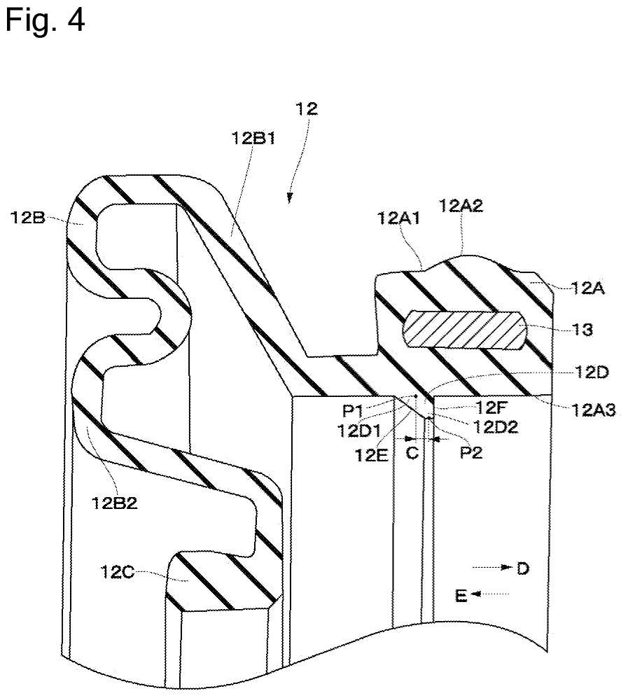

As illustrated in FIG. 2, the piston boot 12 is provided between the distal end 11A side of the piston 11 and the small-diameter stepped portion 9E1 of the cylinder 9. The piston boot 12 extends/compresses according to a movement of the piston 11, and plays a role of sealing between the inner peripheral surface of the cylinder 9 (the bore portion 9A) and the outer peripheral surface 11B of the piston 11 and preventing a foreign object such as dust and rainwater from entering there. As illustrated in FIGS. 3 and 4, the piston boot 12 is integrally molded with use of a flexible material such as rubber and synthetic resin, and includes the large-diameter fitted portion 12A, a metallic member 13, the bellows portion 12B, the small-diameter fitted portion 12C, and an annular protrusion portion 12D.

The large-diameter fitted portion 12A as a fitted portion is disposed by being fitted to the small-diameter stepped portion 9E1 of the cylinder 9. The large-diameter fitted portion 12A is formed annularly (cylindrically) in correspondence with the small-diameter stepped portion 9E1 of the cylinder 9, and contains the annular metallic member 13. Now, the metallic member 13 is formed by an annular member having a diameter larger than the inner diameter of the bore portion 9A of the cylinder 9 and smaller than the diameter dimension of the small-diameter stepped portion 9E1, and is molded integrally with the piston boot 12. The metallic member 13 enhances the rigidity of the large-diameter fitted portion 12A. Further, an annular outer peripheral protrusion 12A2 is provided on an outer peripheral surface 12A1 of the large-diameter fitted portion 12A along the entire circumference thereof. The outer peripheral protrusion 12A2 functions to prevent the large-diameter fitted portion 12A from being detached off from the small-diameter stepped portion 9E1 of the cylinder 9 by being fitted to an annular recessed portion 9G formed on the inner peripheral surface of the small-diameter stepped portion 9E1 of the cylinder 9.

The bellows portion 12B extends from the large-diameter fitted portion 12A and is placed in the large-diameter stepped portion 9E2 of the cylinder 9. The bellows portion 12B includes an extension portion 12B1 and an extensible/compressible portion 12B2. The extension portion 12B1 extends from the large-diameter fitted portion 12A toward the opening edge 9D side of the cylinder 9, and increases in diameter to reach as far as the radially outer side of the outer peripheral surface 12A1 of the large-diameter fitted portion 12A. The extensible/compressible portion 12B2 is folded back radially inward while being deflected in a bellows-like manner from the outer peripheral end of the extension portion 12B1. The small-diameter fitted portion 12C is provided at the radially inner end portion of the extensible/compressible portion 12B2 forming the bellows portion 12B. The small-diameter fitted portion 12C is fitted to the annular groove 11C of the piston 11, and axially moves according to the movement of the piston 11.

The annular protrusion portion 12D is provided on the inner peripheral surface 12A3 of a large-diameter fitted portion 12A. The annular protrusion portion 12D is disposed on the inner peripheral side of the metallic member 13, and annularly protrudes from the inner peripheral surface 12A3 of the large-diameter fitted portion 12A along the entire circumference thereof. The annular protrusion portion 12D secures the sealability between the piston 11 and the piston boot 12 by abutting against the outer peripheral surface 11B of the piston 11. Now, the annular protrusion portion 12D is formed into an annular shape trapezoidal in cross section by a protrusion base portion 12D1 and a protrusion distal end portion 12D2. The protrusion base portion 12D1 protrudes from the inner peripheral surface 12A3 of the large-diameter fitted portion 12A radially inward. The protrusion distal end portion 12D2 is located at the distal end portion of the protrusion base portion 12D1, and abuts against the outer peripheral surface 11B of the piston 11. In this case, the surface of the annular protrusion portion 12D that is located on the opening edge 9D side of the cylinder 9 serves as an inclined surface 12E obtusely intersecting with the inner peripheral surface 12A3 of the large-diameter fitted portion 12A. The surface of the annular protrusion portion 12D that is located on the bottom portion 9B side of the cylinder 9 (the bore portion 9A) serves as a perpendicular surface 12F perpendicularly intersecting with the inner peripheral surface 12A3 of the large-diameter fitted portion 12A.

As illustrated in FIG. 4, assuming that P1 represents the central position of the protrusion base portion 12D1 in the axial direction of the piston 11, and P2 represents the central position of the protrusion distal end portion 12D2 in the axial direction of the piston 11, the central position P2 of the protrusion distal end portion 12D2 is positioned closer to the bottom portion 9B side of the bore portion 9A of the cylinder 9 than the central position P1 of the protrusion base portion 12D1 is by a dimension C. Due to this configuration, the rigidity of the annular protrusion portion 12D against a force directed from the opening edge 9D side toward the bottom portion 9B side of the bore portion 9A of the cylinder 9 (a direction indicated by an arrow D in FIG. 4) is lower than the rigidity thereof against a force directed from the bottom portion 9B toward the opening edge 9D side of the bore portion 9A (a direction indicated by an arrow E in FIG. 4) in the axial direction of the piston 11. In other words, the annular protrusion portion 12D is shaped so as to be easily elastically deformable along the direction indicated by the arrow D but is little elastically deformable in the direction indicated by the arrow E.

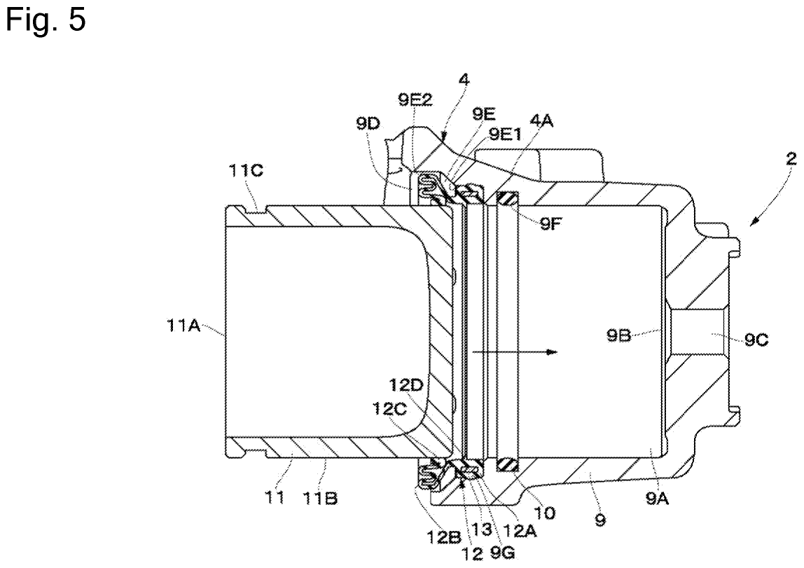

The disk brake 2 according to the first embodiment is configured in the above-described manner, and, in the following description, work of mounting the piston 11 into the bore portion 9A of the cylinder 9 will be described with reference to FIGS. 5 to 7.

When the piston 11 is mounted into the bore portion 9A of the cylinder 9, the large-diameter fitted portion 12A of the piston boot 12 is fitted into the small-diameter stepped portion 9E1 of the cylinder 9 and the bellows portion 12B is placed in the large-diameter fitted portion 12A as illustrated in FIG. 5. Next, the piston 11 is inserted through inside the small-diameter fitted portion 12C of the piston boot 12, and this piston 11 is inserted into the bore portion 9A of the cylinder 9. At this time, lubricant oil or the like is applied onto the outer peripheral surface 11B of the piston 11 or the annular protrusion portion 12D of the piston boot 12 to excellently secure slidability between them.

The piston 11 is further inserted into the bore portion 9A of the cylinder 9 in this state. At this time, the outer peripheral surface 11B of the piston 11 is brought into abutment with the annular protrusion portion 12D of the piston boot 12 and this annular protrusion portion 12D is tilted (elastically deformed) toward the bottom portion 9B side of the bore portion 9A, by which the piston 11 passes through the annular protrusion portion 12D and is inserted to as far as near the bottom portion 9B. Then, the small-diameter fitted portion 12C of the piston boot 12 is fitted into the annular groove 11C of the piston 11. By these processes, the piston 11 can be mounted in the bore portion 9A of the cylinder 9 (refer to FIG. 2).

On the other hand, in the case where the annular metallic member is contained in the fitted portion of the piston boot according to the conventional technique, the rigidity of the fitted portion and the rigidity of the annular protrusion portion of the piston boot increase. Therefore, when the disk brake is assembled, the piston is inserted into the bore portion of the cylinder without the annular protrusion portion of the piston boot sufficiently tilted in the piston insertion direction. Under this situation, the lubricant oil applied on the outer peripheral surface of the piston is undesirably scraped off by the annular protrusion portion when the piston is inserted into the bore portion of the cylinder. As a result, the lubricant oil falls short between the annular protrusion portion of the piston boot and the outer peripheral surface of the piston with the piston mounted in the bore portion of the cylinder, and this insufficiently leads to an undesirable reduction in the slidability of the piston on the piston boot. The conventional technique involves such a problem.

Therefore, the annular protrusion portion 12D of the piston boot 12 according to the first embodiment is formed in such a manner that the rigidity against the force directed from the opening edge 9D toward the bottom portion 9B side of the bore portion 9A is lower than the rigidity against the force directed from the bottom portion 9B toward the opening edge 9D side of the bore portion 9A in the axial direction of the piston 11. This configuration makes it easier for the annular protrusion portion 12D of the piston boot 12 according to the first embodiment to be elastically deformed and tilted (bent) toward the bottom portion 9B side of the bore portion 9A when the piston 11 is mounted (inserted) into the bore portion 9A of the cylinder 9. This can prevent the lubricant oil applied on the outer peripheral surface 11B of the piston 11 from being scraped off by the annular protrusion portion 12D. As a result, the present configuration can secure sufficient lubricant oil between the annular protrusion portion 12D of the piston boot 12 and the outer peripheral surface 11B of the piston 11 and excellently secure the slidability of the piston 11 on the piston boot 12.

In other words, according to the first embodiment, it is possible to reduce the sliding resistance between the annular protrusion portion 12D of the piston boot 12 and the outer peripheral surface 11B of the piston 11 when the disk brake 2 is actuated, and excellently maintain the slidability of the piston 11 on the annular protrusion portion 12D. Further, it is possible to improve the workability when the piston 11 is mounted into the bore portion 9A of the cylinder 9.

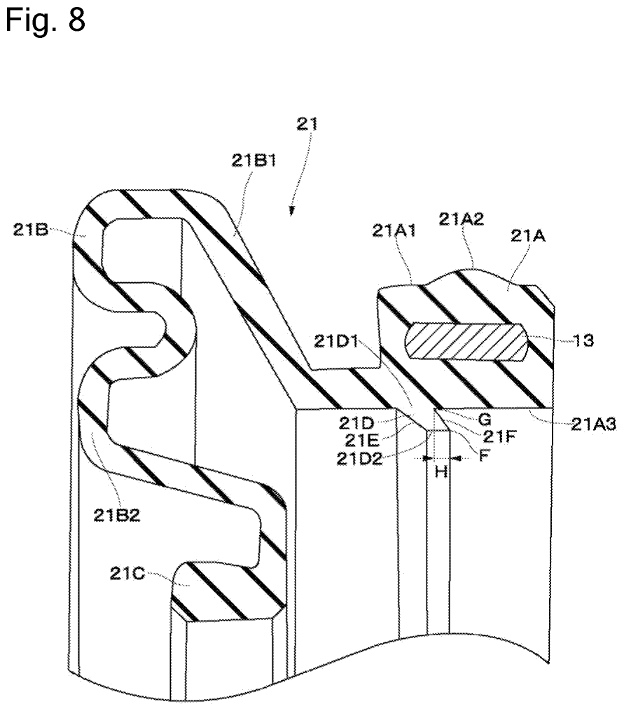

Next, FIG. 8 illustrates a second embodiment of the present invention. The second embodiment is characterized in that the protrusion distal end portion of the annular protrusion portion provided to the piston boot is disposed offset closer to the bottom portion side of the bore portion than the protrusion base portion is in the axial direction of the piston. The second embodiment will be described, identifying similar constituent components to the first embodiment by the same reference numerals and omitting descriptions thereof.

A piston boot 21 illustrated in FIG. 8 is disposed between the distal end 11A side of the piston 11 and the small-diameter stepped portion 9E1 of the cylinder 9, similarly to the piston boot 12 according to the first embodiment. Similarly to the piston boot 12 according to the first embodiment, the piston boot 21 includes a large-diameter fitted portion 21A, a bellows portion 21B including an extension portion 21B1 and an extensible/compressible portion 21B2, a small-diameter fitted portion 21C, and an annular protrusion portion 21D, and the metallic member 13 is contained in the large-diameter fitted portion 21A. Then, an outer peripheral protrusion 21A2 is provided on an outer peripheral surface 21A1 of the large-diameter fitted portion 21A, and the annular protrusion portion 21D is formed on an inner peripheral surface 21A3 of the large-diameter fitted portion 21A. However, the shape of the annular protrusion portion 21D is different from the annular protrusion portion 12D of the piston boot 12 according to the first embodiment.

The annular protrusion portion 21D of the piston boot 21 is disposed on the inner peripheral side of the metallic member 13, and protrudes annularly from the inner peripheral surface 21A3 of the large-diameter fitted portion 21A along the entire circumference thereof. Then, the annular protrusion portion 21D is formed into an annular shape trapezoidal in cross section by a protrusion base portion 21D1 and a protrusion distal end portion 21D2. The protrusion base portion 21D1 protrudes from the inner peripheral surface 21A3 of the large-diameter fitted portion 21A radially inward. The protrusion distal end portion 21D2 is located at the distal end portion of the protrusion base portion 21D1, and abuts against the outer peripheral surface 11B of the piston 11. In this case, an end portion F of the protrusion distal end portion 21D2 on the bottom portion 9B side of the cylinder 9 (the bore portion 9A) is positioned closer to the bottom portion 9B side than an end portion G of the protrusion base portion 21D1 on the bottom portion 9B side of the bore portion 9A is by a dimension H.

In other words, the protrusion distal end portion 21D2 of the annular protrusion portion 21D is disposed offset closer to the bottom portion 9B side of the bore portion 9A than the protrusion base portion 21D1 is in the axial direction of the piston 11. Due to this configuration, the surface of the annular protrusion portion 21D that is located on the opening edge 9D side of the bore portion 9A serves as an inclined surface 21E obtusely intersecting with the inner peripheral surface 21A3 of the large-diameter fitted portion 21A. The surface of the annular protrusion portion 21D that is located on the bottom portion 9B side of the bore portion 9A serves as an inclined surface 21F intersecting at an acute angle with the inner peripheral surface 21A3 of the large-diameter fitted portion 21A.

The disk brake according to the second embodiment includes the piston boot 21 configured in this manner, and the basic operation thereof is not especially different from the operation according to the first embodiment.

Especially, the annular protrusion portion 21D of the piston boot 21 according to the second embodiment is shaped so as to be inclined toward the bottom portion 9B side of the bore portion 9A in the state that the surface thereof located on the bottom portion 9B side of the bore portion 9A intersects at the acute angle with the inner peripheral surface 21A3 of the large-diameter fitted portion 21A. This configuration can contribute to further reducing the rigidity of the annular protrusion portion 21D against the force directed from the opening edge 9D side toward the bottom portion 9B of the bore portion 9A, thereby allowing sufficient lubricant oil to remain on the outer peripheral surface 11B of the piston 11 when the piston 11 is inserted into the bore portion 9A of the cylinder 9. As a result, the present configuration can secure sufficient lubricant oil between the annular protrusion portion 21D and the outer peripheral surface 11B of the piston 11 with the piston 11 mounted in the bore portion 9A of the cylinder 9, thereby further excellently maintaining the slidability of the piston 11 on the annular protrusion portion 21D.

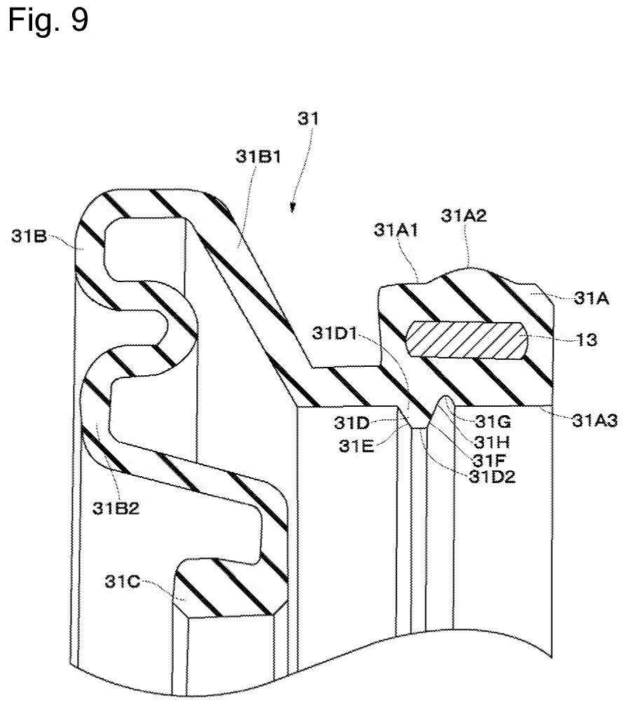

Next, FIG. 9 illustrates a third embodiment of the present invention. The third embodiment is characterized in that the annular protrusion portion of the piston boot includes an annular groove formed on the base portion located on the bottom portion side of the bore portion. The third embodiment will be described, identifying similar constituent components to the first embodiment by the same reference numerals and omitting descriptions thereof.

A piston boot 31 illustrated in FIG. 9 is disposed between the distal end 11A side of the piston 11 and the small-diameter stepped portion 9E1 of the cylinder 9, similarly to the piston boot 12 according to the first embodiment. Similarly to the piston boot 12 according to the first embodiment, the piston boot 31 includes a large-diameter fitted portion 31A, a bellows portion 31B including an extension portion 31B1 and an extensible/compressible portion 31B2, a small-diameter fitted portion 31C, and an annular protrusion portion 31D, and the metallic member 13 is contained in the large-diameter fitted portion 31A. Then, an outer peripheral protrusion 31A2 is provided on an outer peripheral surface 31A1 of the large-diameter fitted portion 31A. On the other hand, the annular protrusion portion 31D is formed on an inner peripheral surface 31A3 of the large-diameter fitted portion 31A. However, the shape of the annular protrusion portion 31D is different from the annular protrusion portion 12D of the piston boot 12 according to the first embodiment.

The annular protrusion portion 31D of the piston boot 31 is disposed on the inner peripheral side of the metallic member 13, and protrudes annularly from the inner peripheral surface 31A3 of the large-diameter fitted portion 31A along the entire circumference thereof. Then, the annular protrusion portion 31D is formed into an annular shape trapezoidal in cross section by a protrusion base portion 31D1 and a protrusion distal end portion 31D2. The protrusion base portion 31D1 protrudes from the inner peripheral surface 31A3 of the large-diameter fitted portion 31A radially inward. The protrusion distal end portion 31D2 is located at the distal end portion of the protrusion base portion 31D1, and abuts against the outer peripheral surface 11B of the piston 11. In this case, the surface of the annular protrusion portion 31D that is located on the opening edge 9D side of the cylinder 9 serves as an inclined surface 31E obtusely intersecting with the inner peripheral surface 31A3 of the large-diameter fitted portion 31A. The surface of the annular protrusion portion 31D that is located on the bottom portion 9B side of the cylinder 9 (the bore portion 9A) serves as an inclined surface 31F obtusely intersecting with the inner peripheral surface 31A3 of the large-diameter fitted portion 31A.

Then, an annular groove 31G is provided at a base portion 31H of the protrusion base portion 31D1 that is located on the bottom portion 9B side of the bore portion 9A of the cylinder 9. This annular groove 31G is formed as an annular groove recessed radially outward (toward the outer peripheral surface 31A1 side) beyond the inner peripheral surface 31A3 of the large-diameter fitted portion 31A along the entire circumference thereof. In other words, the annular protrusion portion 31D of the piston boot 31 according to the third embodiment includes the annular groove 31G formed at the protrusion base portion 31D1 located on the bottom portion 9B side of the bore portion 9A. Due to this configuration, the rigidity of the annular protrusion portion 31D against the force directed from the opening edge 9D toward the bottom portion 9B side of the bore portion 9A is lower than the rigidity thereof against the force directed from the bottom portion 9B toward the opening edge 9D side of the bore portion 9A in the axial direction of the piston 11.

The disk brake according to the third embodiment includes the piston boot 31 configured in this manner, and the basic operation thereof is not especially different from the operation according to the first embodiment.

Especially, the piston boot 31 according to the third embodiment can reduce the rigidity of the annular protrusion portion 31D against the force directed from the opening edge 9D side toward the bottom portion 9B of the bore portion 9A by providing the annular groove 31G at the base portion 31H of the protrusion base portion 31D1 that is located on the bottom portion 9B side of the bore portion 9A of the cylinder 9. As a result, the present configuration can allow sufficient lubricant oil to remain on the outer peripheral surface 11B of the piston 11 when the piston 11 is inserted into the bore portion 9A of the cylinder 9, thereby excellently maintaining the slidability of the piston 11 on the annular protrusion portion 31D with the piston 11 mounted in the bore portion 9A of the cylinder 9.

Each of the above-described embodiments has been described referring to the disk brake 2 including one pair of the bore portion 9A and the piston 11 by way of example. However, the present invention is not limited thereto, and can also be applied to, for example, an opposed-type disk brake in which the disk brake includes two pairs of bore portions and pistons, and the opposed pistons are disposed on the both sides of the disk axially and press the pads from the both sides.

Possible configurations as a disk brake and a piston boot based on the above-described embodiments include the following examples.

As a first configuration, a disk brake includes a cylinder including a bottomed bore portion in which a piston is received movably in an axial direction of this piston. The cylinder includes an annular stepped portion formed on an opening edge side of the bore portion on which a distal end of the piston protrudes. The annular stepped portion has a larger diameter dimension than an inner diameter of the bore portion. The disk brake includes the piston configured to press at least one of a pair of pads facing both surfaces of a disk, respectively, and a piston boot disposed between a distal end side of the piston and the stepped portion of the cylinder. The piston boot includes a bellows portion extensible and compressible according to a movement of the piston. The piston boot includes an annular fitted portion formed integrally with the bellows portion. The fitted portion contains an annular metallic member, and is configured to be fitted to the stepped portion. The piston boot further includes an annular protrusion portion provided on an inner peripheral side of the fitted portion. The annular protrusion portion is configured to abut against an outer peripheral surface of the piston. Rigidity of the annular protrusion portion against a force directed from the opening edge side of the bore portion toward a bottom portion of the bore portion in the axial direction of the piston is lower than rigidity thereof against a force directed from the bottom portion of the bore portion toward the opening edge side of the bore portion in the axial direction of the piston.

As a second configuration, in the first configuration, the annular protrusion portion includes a protrusion base portion and a protrusion distal end portion. The protrusion base portion protrudes from an inner peripheral surface of the fitted portion radially inward. The protrusion distal end portion is located at a distal end of the protrusion base portion, and configured to abut against the outer peripheral surface of the piston. A central position of the protrusion distal end portion in the axial direction of the piston is located closer to a bottom portion side of the bore portion than a central position of the protrusion base portion in the axial direction of the piston is.

As a third configuration, in the second configuration, the protrusion distal end portion is disposed offset closer to the bottom portion side of the bore portion than the protrusion base portion is in the axial direction of the piston.

As a fourth configuration, in the first configuration, the annular protrusion portion includes an annular groove formed at a base portion located on a bottom portion side of the bore portion.

A fifth configuration is a piston boot. This piston boot is disposed between a stepped portion formed on an opening edge side of a cylinder and a distal end side of a piston. The cylinder is provided in a caliper of a disk brake, and includes a bottomed bore portion. The piston is received in the bore portion movably in an axial direction of the piston. The piston boot includes a bellows portion extensible and compressible according to a movement of the piston, and an annular fitted portion formed integrally with the bellows portion. The fitted portion contains an annular metallic member, and is configured to be fitted to the stepped portion. The piston boot further includes an annular protrusion portion provided on an inner peripheral side of the fitted portion. The annular protrusion portion is configured to abut against an outer peripheral surface of the piston. Rigidity of the annular protrusion portion against a force directed from the opening edge side of the bore portion toward a bottom portion of the bore portion in the axial direction of the piston is lower than rigidity thereof against a force directed from the bottom portion of the bore portion toward the opening edge side of the bore portion in the axial direction of the piston.

As a sixth configuration, in the fifth configuration, the annular protrusion portion includes a protrusion base portion and a protrusion distal end portion. The protrusion base portion protrudes from an inner peripheral surface of the fitted portion radially inward. The protrusion distal end portion is located at a distal end of the protrusion base portion, and configured to abut against the outer peripheral surface of the piston. A central position of the protrusion distal end portion in the axial direction of the piston is located closer to a bottom portion side of the bore portion than a central position of the protrusion base portion in the axial direction of the piston is.

As a seventh configuration, in the sixth configuration, the protrusion distal end portion is disposed offset closer to the bottom portion side of the bore portion than the protrusion base portion is in the axial direction of the piston.

As an eighth configuration, in the fifth configuration, the annular protrusion portion includes an annular groove formed at a base portion located on a bottom portion side of the bore portion.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each of the embodiments can also be implemented with another configuration added, deleted, or replaced with respect to a part of the configuration of this embodiment.

The present application claims priority under the Paris Convention to Japanese Patent Application No. 2018-121838 filed on Jun. 27, 2018. The entire disclosure of Japanese Patent Application No. 2018-121838 filed on Jun. 27, 2018 including the specification, the claims, the drawings, and the abstract is incorporated herein by reference in its entirety.

### REFERENCE SIGNS LIST

1 disk
2 disk brake
4 caliper
8 friction pad (pad)
9 cylinder
9A bore portion
9B bottom portion
9D opening edge
9E stepped portion
9E1 small-diameter stepped portion (stepped portion)
11 piston
11A distal end
11B outer peripheral surface
12, 21, 31 piston boot
12A, 21A, 31A large-diameter fitted portion (fitted portion)
12A3, 21A3, 31A3 inner peripheral surface
12B, 21B, 31B bellows portion
12D, 21D, 31D annular protrusion portion
12D1, 21D1, 31D1 protrusion base portion
12D2, 21D2, 31D2 protrusion distal end portion
13 metallic member
31G annular groove
31H base portion
P1 central position
P2 central position

1. A disk brake comprising:
a cylinder including a bottomed bore portion in which a piston is received movably in an axial direction of this piston, the cylinder including an annular stepped portion formed on an opening edge side of the bore portion on which a distal end of the piston protrudes, the annular stepped portion having a larger diameter dimension than an inner diameter of the bore portion;
the piston configured to press at least one of a pair of pads facing both surfaces of a disk, respectively; and
a piston boot disposed between a distal end side of the piston and the stepped portion of the cylinder, the piston boot including a bellows portion extensible and compressible according to a movement of the piston,
the piston boot including
an annular fitted portion formed integrally with the bellows portion, the fitted portion containing an annular metallic member and being configured to be fitted to the stepped portion, and
an annular protrusion portion provided on an inner peripheral side of the fitted portion, the annular protrusion portion being configured to abut against an outer peripheral surface of the piston, and
wherein rigidity of the annular protrusion portion against a force directed from the opening edge side of the bore portion toward a bottom portion of the bore portion in the axial direction of the piston is lower than rigidity thereof against a force directed from the bottom portion of the bore portion toward the opening edge side of the bore portion in the axial direction of the piston.

2. The disk brake according to claim 1, wherein the annular protrusion portion includes a protrusion base portion and a protrusion distal end portion, the protrusion base portion that protrudes from an inner peripheral surface of the fitted portion radially inward, the protrusion distal end portion being located at a distal end of the protrusion base portion and configured to abut against the outer peripheral surface of the piston, and
wherein a central position of the protrusion distal end portion in the axial direction of the piston is located closer to a bottom portion side of the bore portion than a central position of the protrusion base portion in the axial direction of the piston is.

3. The disk brake according to claim 2, wherein the protrusion distal end portion is disposed offset closer to the bottom portion side of the bore portion than the protrusion base portion is in the axial direction of the piston.

4. The disk brake according to claim 1, wherein the annular protrusion portion includes an annular groove formed at a base portion located on a bottom portion side of the bore portion.

5. A piston boot, the piston boot being disposed between a stepped portion formed on an opening edge side of a cylinder and a distal end side of a piston, the cylinder being provided in a caliper of a disk brake and including a bottomed bore portion, the piston being received in the bore portion movably in an axial direction of the piston,
the piston boot comprising:
a bellows portion extensible and compressible according to a movement of the piston;
an annular fitted portion formed integrally with the bellows portion, the fitted portion containing an annular metallic member and being configured to be fitted to the stepped portion; and
an annular protrusion portion provided on an inner peripheral side of the fitted portion, the annular protrusion portion being configured to abut against an outer peripheral surface of the piston,
wherein rigidity of the annular protrusion portion against a force directed from the opening edge side of the bore portion toward a bottom portion of the bore portion in the axial direction of the piston is lower than rigidity thereof against a force directed from the bottom portion of the bore portion toward the opening edge side of the bore portion in the axial direction of the piston.

6. The piston boot according to claim 5, wherein the annular protrusion portion includes a protrusion base portion and a protrusion distal end portion,
wherein the protrusion base portion protrudes from an inner peripheral surface of the fitted portion radially inward, the protrusion distal end portion being located at a distal end of the protrusion base portion and configured to abut against the outer peripheral surface of the piston, and
wherein a central position of the protrusion distal end portion in the axial direction of the piston is located closer to a bottom portion side of the bore portion than a central position of the protrusion base portion in the axial direction of the piston is.

7. The piston boot according to claim 6, wherein the protrusion distal end portion is disposed offset closer to the bottom portion side of the bore portion than the protrusion base portion is in the axial direction of the piston.

8. The piston boot according to claim 5, wherein the annular protrusion portion includes an annular groove formed at a base portion located on a bottom portion side of the bore portion.
